(19) United States
(12) Patent Application Publication
(10) Pub. No.: US 2009/0120766 A1
(43) Pub. Date: May 14, 2009

(54) Roller for a roller conveyor

(75) Inventors: Christoph Markle, Freiburg (DE); Davorin Jaksic, Denzlingen (DE)

Correspondence Address: THE NATH LAW GROUP, 112 South West Street, Alexandria, VA, 22314, US

(73) Assignee: SICK AG, Waldkirch (DE)

(21) Appl. No.: 12/289,944

(22) Filed: Nov. 7, 2008

(30) Foreign Application Priority Data
Nov. 8, 2007 (DE) 20 2007 015 529.8

(51) Int. Cl. B65G 13/06

(52) U.S. Cl. 198/781.05

(57) ABSTRACT

Disclosed is a roller for a roller conveyor, in particular for conveying systems or logistics systems. The roller has an integrated capacitive sensor, characterized in that at least one reference sensor is arranged at the side of the roller remote from the conveying side. The integrated capacitive sensor is also characterized in that an evaluation unit is provided, which is made such that a switching signal can be provided from a difference signal between a sensor signal and a reference sensor signal when a sensor signal is conveyed.

### FIELD OF THE INVENTION

The invention relates to a roller for a roller conveyor, in particular for conveying systems and/or logistics systems having an integrated capacitive sensor.

### BACKGROUND

In storage and conveying technology, it is necessary to detect the presence of the conveyed product such as boxes and packages at specific positions of the conveying path in order to control the material flow. For this purpose, among other things, optical, magnetic or capacitive sensors are attached to the corresponding location of the conveying path to detect the conveyed product on the roller conveyor.

Detection takes place with the help of the sensors usually attached externally to the conveying path. They must be installed at the conveying path in a complex and/or costly manner using a suitable fastening technology and must be connected with the help of a separate wiring harness to the energy supply, on the one hand, and to the communication network (a central control unit or a ladder network to the adjacent sensors)), on the other hand. Further disadvantages are the additional space requirements and additional costs as well as complex individual adjustment of the numerous separately installed sensors. Furthermore, externally installed sensors are generally prone to mechanical impairments by the environment, e.g. due to contamination, damage to the detection surface, etc. The maintenance effort is thereby increased and a rugged housing design is necessary for the mechanical protection of the sensors, which causes additional costs. In addition, the separate sensors have to be wired.

A roller for roller conveyors is known from DE 101 31 019 A 1 in which a capacitive sensor is integrated in the roller. The capacitive sensors are installed in this respect so that their electrical detection field is aligned in the direction of the conveyed product. If a conveyed product now moves over the roller, a detuning of the electrical field takes place. In this process, the sensor recognizes the presence of a conveyed product and reports it to its switching output. In accordance with DE 101 31 019 A1, the capacitive sensors would have to be aligned so that the rollers are masked. No further disclosure is made on how this should be done.

### SUMMARY

Starting from this prior art, it is the object of the invention to provide an improved roller having a capacitive sensor which can be implemented, does not require any complex and/or costly adjustment and which reliably detects conveyed product.

This object is satisfied by a roller for a roller conveyor having the features of claim 1.

The roller in accordance with the invention for a roller conveyor, in particular for conveying systems and/or logistics systems, has an integrated capacitive sensor and is characterized in that at least one reference sensor is arranged at the side of the roller remote from the conveying side and in that an evaluation unit is provided which is made such that a switching signal can be provided from a difference signal between a sensor signal and a reference sensor signal when an object is conveyed over the roller.

If a capacitive reference sensor is provided in addition to a capacitive sensor, a simple equalization between the two sensors can be carried out on the putting into operation of the roller so that the difference of the signals of these two sensors amounts to zero. No adjustment or complex and/or expensive alignment of the sensor field is required for this purpose. In operation, on the presence of a conveyed product, the sensor will deliver a signal different with respect to the reference sensor so that the difference signal differs from zero and a conveyed product presence signal can be output in a simple evaluation. Such an embodiment and the thus possible detection method for conveyed product is substantially independent of the environmental conditions such as air humidity, coatings on the roller, etc. since influences on the measured signals are compensated by the reference sensor.

So that the sensor only detects on the conveying side and has a detection zone which is as large as possible, the sensor is arranged stationary at one axis and as close as possible to the inner side of a rotating outer cylinder.

If the detection area of the sensor is narrower than the zone in which conveyed products pass the roller, it is advantageous to arrange further sensors sequentially in the longitudinal direction of the roller so that the total zone in which conveyed products are detected is covered.

An evaluation unit for the sensors is advantageously integrated in the roller itself so that the roller forms a self-contained unit.

It must be mentioned that a specific number of non-driven rollers can by all means be located in a roller conveyor beside the driving rollers. It is furthermore also possible that the movement of electrically driven driving rollers is transferred to motor-less rollers via coupling elements. The roller in accordance with the invention can either be a driving roller so that it therefore has an integrated drive connectable to an electrical energy supply or the roller in accordance with the invention can be integrated in passive rollers, that is non-driven or motor-less rollers.

### BRIEF DESCRIPTION OF THE DRAWING

FIG. 1 is a cross-sectional view of a roller for a roller conveyer.

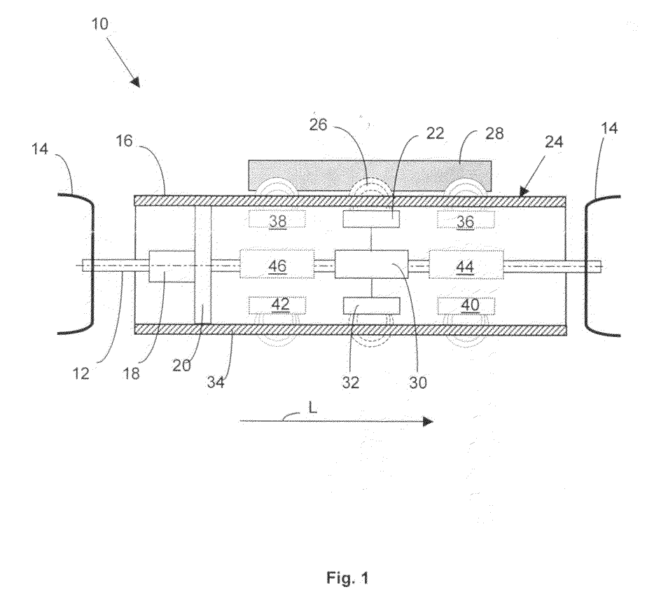

The invention will be described in detail in the following with reference to an embodiment and to the drawing.

### DETAILED DESCRIPTION

The only FIGURE of the drawing shows a schematic representation of a cross-section through a roller 10 in accordance with the invention for a roller conveyor. The roller 10 has a fixed axle 12 which is fastened to bearings 14. The roller 10 furthermore includes an outer cylinder 16 which can rotate around the axle 12 and is journaled in a suitable manner. The outer cylinder 16 is driven by a motor 18 arranged in the interior of the roller 10 and by transmission 20.

Furthermore, a capacitive sensor 22 is fastened to the fixed axle 12 in the interior of the roller and its detection zone 26 extends at a conveying side 24 of the roller 10. Objects 28 are conveyed over the roller 10 at the conveying side 24. On presence of the object 28 on the conveying side of the roller 10, the capacitive properties change in the detection zone 26, which is detected by the capacitive sensor 22. The sensor 22 is connected to an evaluation unit 30 which can ultimately output an object detection signal in a suitable manner, not shown.

In accordance with the invention, at least one reference sensor 32 which is likewise a capacitive sensor and sends a reference sensor signal to the evaluation unit is arranged at the side of the roller 10 remote from the conveying side 24 in the interior of the roller 10. Since the reference sensor 32 only “sees” the wall 34 of the outer cylinder 16, the difference between a signal of the sensor 22 and the reference sensor signal should be approximately equal to zero if no object is present on the conveying side and not equal to zero on the presence of an object.

If the detection range 26 of the sensor 22 is relatively small in comparison with the zone in which objects can occur, it is sensible to arrange further capacitive sensors 36, 38 sequentially in the longitudinal direction L of the roller 10 so that substantially the total length of the roller bearing conveyed product is detected by the sensors 42, 36, 38. In a further development of the invention, further reference sensors 40, 42 could be arranged on the oppositely disposed side. All these further sensors can be connected to the one evaluation unit 30 or to additional evaluation units at 44, 46.

The electrical energy supply for the drive motor 18 and for the sensors as well as for the evaluation unit is effected in a suitable manner, not shown, via a corresponding line. The object detection signal can be transferred to external to a corresponding control of the roller conveyor via lines, likewise not shown, or also in a non-wired manner.

1. A roller for a roller conveyor, in particular for conveying systems and/or logistics systems, having an integrated capacitive sensor, characterized in that at least one reference sensor is arranged at the side of the roller remote from the conveying side; and in that an evaluation unit is provided which is made such that a switching signal can be provided from a difference signal between a sensor signal and a reference sensor signal when an object is conveyed over the roller.

2. A roller in accordance with claim 1, characterized in that the sensor is arranged in fixed position at an axle and as close as possible to the inner side of a rotating outer cylinder of the roller.

3. A roller in accordance with claim 1, characterized in that a plurality of sensors are arranged sequentially in the longitudinal direction of the roller so that substantially the total length of the roller bearing conveyed product is detected by the sensors.

4. A roller in accordance with claim 1, characterized in that the roller has an integrated drive which can be connected to an electrical energy supply.

5. A roller in accordance with claim 1, characterized in that the evaluation unit is integrated into the roller.
